(19) United States
(12) Patent Application Publication
(10) Pub. No.: US 2015/0171449 A1
(43) Pub. Date: Jun. 18, 2015

(54) Method and Apparatus for Generating and Managing Energy

(71) Applicant: David W. McCary, West Hartford, CT (US)

(72) Inventor: David W. McCary, West Hartford, CT (US)

(21) Appl. No.: 14/632,593

(22) Filed: Feb. 26, 2015

Related U.S. Application Data
(63) Continuation-in-part of application No. 12/002,387, filed on Dec. 17, 2007.

(51) Int. Cl. H01M 8/06

(52) U.S. Cl. CPC H01M 8/0656; H01M 2250/405; H01M 2250/407; H01M 2250/10

(57) ABSTRACT

A system for generating power for a building is provided, wherein the system includes a hydrogen source, a plurality of power generation sources and a hydrogen recovery article, wherein the hydrogen recovery article is configured to interact with the hydrogen source and the plurality of power generation sources to generate hydrogen. The system includes a hydrogen storage tank for containing hydrogen, an electrical energy generation device associated with the hydrogen storage tank and configured to receive the hydrogen, wherein the electrical energy generation device is configured to convert the hydrogen into electricity, and a plurality of power consuming articles in electrical communication with the electrical energy generation device such that the plurality of power consuming articles receives electricity from the electrical energy generation device.

### CROSS-REFERENCE TO RELATED PATENT APPLICATIONS

The present application is a continuation-in-part application of U.S. patent application Ser. No. 12/002,387 and claims the benefit of priority of U.S. patent application Ser. No. 12/002,387 (Attorney Docket No. NET-0002) and U.S. Provisional Patent Application Ser. No.: 60/875,478 (Attorney Docket No. NET-0002-P), both of which are entitled Method and Apparatus for Generating and Managing Energy, the contents of both of which are incorporated by reference herein in their entireties.

### FIELD OF THE INVENTION

This invention relates generally to the generation and storage of energy and more particularly to the clean generation and storage of energy using a hybrid system of clean energy generation/storage means.

### BACKGROUND OF THE INVENTION

As the world's population increases, so does the amount of energy being consumed. Unfortunately, this increased energy consumption has several undesirable consequences. One such consequence involves the type of fuel being used to generate the increased amount of energy. This is because traditional fuel resources, such as coal, oil and natural gas, are typically burned to generate the required energy. This combustion process generates pollutants that are released into the atmosphere and that have a deleterious effect on both people and the environment. For example, the combustion of fossil fuels generates greenhouse gases, such as carbon dioxide, which build up in the upper portion of the atmosphere. When sunlight is incident on the earth, these gases allow the sunlight to enter the atmosphere freely. The sunlight strikes the earths' surface where some of it is reflected back towards space as infrared radiation (i.e. heat). This infrared radiation is then absorbed and trapped by the greenhouse gases that have built up in the atmosphere, thus causing an increase in global temperatures.

Another such consequence involves the quantity of the fuel being used to generate the increased amount of energy. As mention hereinbefore, fossil fuels are typically used to generate the energy required by the majority of the world's population. However, because fossil fuels are a non-renewable energy resource with finite global reserves, once these reserves have been depleted alternative sources of energy must be found. Additionally, as these resources become more scarce the cost of locating, mining and processing these fuels increases. This is undesirable because these costs are passed onto the consumer.

### SUMMARY OF THE INVENTION

A system for generating power for a building is provided, wherein the system includes a hydrogen source, a hydrogen storage tank for containing hydrogen obtained from the hydrogen source and a hydrogen converting device configured to receive the hydrogen from the hydrogen storage tank, wherein the hydrogen converting device is configured to convert the hydrogen into energy

A system for generating power is provided and includes a hydrogen storage tank for containing hydrogen, wherein the hydrogen storage tank includes a first hydrogen tank port and a second hydrogen tank port, the first hydrogen tank port being configured to allow a hydrogen powered device to interface with the hydrogen tank and transfer hydrogen between the hydrogen tank and the hydrogen powered device, an electrical energy generation device associated with the hydrogen storage tank via the second hydrogen tank port, the electrical energy generation device configured to receive the hydrogen from the hydrogen storage tank and generate electricity from the hydrogen, a power distribution device in electrical communication with the electrical energy generation device to receive the electricity, the power distribution device being configurable to distribute the electricity in a predetermined manner and at least one power port communicated with the power distribution device, wherein the power port is configured to interface with an electric device.

A method for generating and managing energy via a system for generating power from hydrogen is provided, wherein the method includes obtaining hydrogen from a hydrogen source, converting the hydrogen into electrical energy and distributing the electrical energy as desired.

A system for generating power for a building is provided, wherein the system includes a hydrogen source, a plurality of power generation sources and a hydrogen recovery article, wherein the hydrogen recovery article is configured to interact with the hydrogen source and the plurality of power generation sources to generate hydrogen. The system further includes a hydrogen storage tank for containing the hydrogen, an electrical energy generation device associated with the hydrogen storage tank and configured to receive the hydrogen, wherein the electrical energy generation device is configured to convert the hydrogen into electricity, and a plurality of power consuming articles in electrical communication with the electrical energy generation device such that the plurality of power consuming articles receives electricity from the electrical energy generation device.

A system for generating power for a building is provided, wherein the system includes a hydrogen source, a plurality of power generation sources and a hydrogen recovery article, wherein the hydrogen recovery article is configured to interact with the hydrogen source and the plurality of power generation sources to generate hydrogen. The system further includes a hydrogen storage tank for containing the hydrogen, an electrical energy generation device associated with the hydrogen storage tank and configured to receive the hydrogen, wherein the electrical energy generation device is configured to convert the hydrogen into electricity and a plurality of power consuming articles in electrical communication with the electrical energy generation device such that the plurality of power consuming articles receives electricity from the electrical energy generation device. The system also includes a power control system in electrical communication with the electrical energy generation device and the plurality of power consuming articles, wherein the power control system monitors power load on the electrical energy generation device from the plurality of power consuming articles and configures the connection between the plurality of power consuming articles and electrical energy generation device in response.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is a schematic diagram depicting an energy generation/storage system in accordance with a first embodiment of the invention;

FIG. 2 is a schematic diagram depicting an energy generation/storage system in accordance with a second embodiment of the invention;

FIG. 3 is a schematic diagram depicting an energy generation/storage system in accordance with a third embodiment of the invention;

FIG. 4 is a schematic diagram depicting an energy generation/storage system in accordance with a fourth embodiment of the invention; and

FIG. 5 is a block diagram illustrating a method for generating and managing power in accordance with one embodiment of the invention.

FIG. 6 is a schematic diagram illustrating an energy generation/storage system in accordance with a another embodiment of the invention;

FIG. 7 is a schematic diagram illustrating the energy generation/storage system of FIG. 6.

FIG. 8 is a schematic diagram illustrating an energy generation/storage system in accordance with still yet another embodiment of the invention.

FIG. 9 is a chart diagram illustrating method for acquiring, storing and deploying an energy generation/storage system, in accordance with still yet a another embodiment of the invention.

FIG. 10 is a block diagram illustrating a method for generating and managing power in accordance with another embodiment of the invention

### DETAILED DESCRIPTION

As disclosed herein an environmentally friendly and economical method and apparatus for producing, storing and managing the energy needs of a consumer is provided in accordance with the present invention. As such, the present invention allows a consumer the ability to take control of all of his/her energy needs (such as heating, hot water, air conditioning, electricity and/or automobile fuel) using one common fuel source, hydrogen. As a brief background, when combined with fuel cells, hydrogen can be used to fuel almost all power consumption devices/systems currently in use by consumers, including but not limited to heating means, hot water producing means, air conditioning means, electrical devices and/or hydrogen operated vehicles (automobiles, boats, motorcycles, etc). In accordance with the present invention, several embodiments of a method and apparatus for a home owner to cleanly and efficiently generate, store and distribute their own power is provided. However, these embodiments are not meant to be limiting and as such, other embodiments not explicitly disclosed herein are contemplated as being within the scope of the present invention.

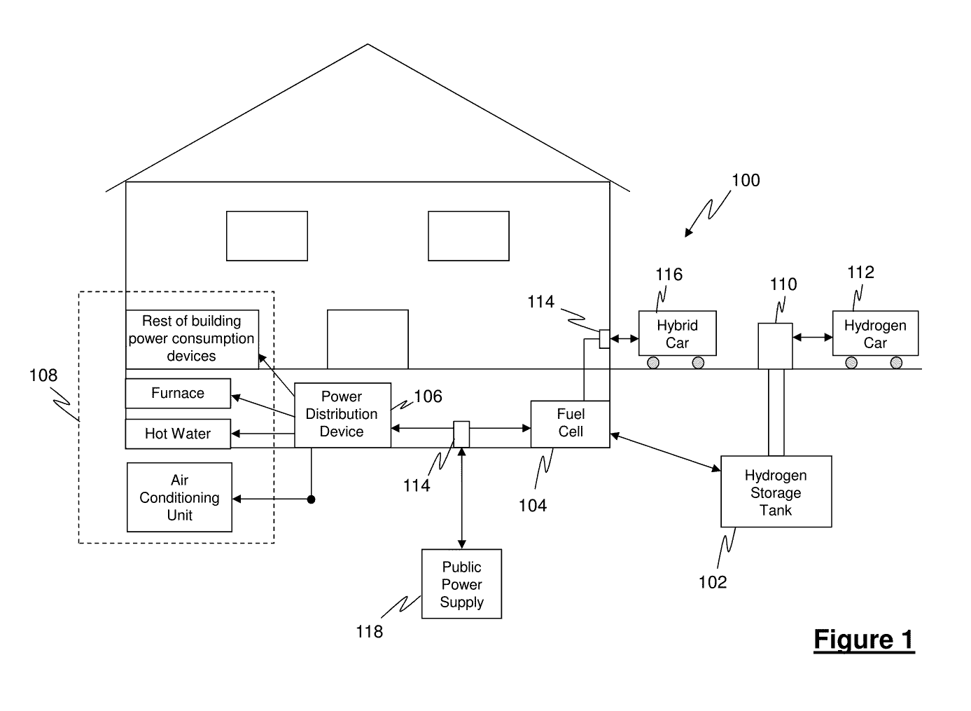

Referring to FIG. 1, a first embodiment of an energy generation and storage system 100 is illustrated and includes a hydrogen storage tank 102 and a power generation device 104 (such as an electrochemical fuel cell) associated with a power distribution device 106 for distributing power generated by power generation device 104 to a plurality of power consuming devices 108. The hydrogen storage tank 102 is associated with the power generation device 104 to allow hydrogen to be transferred between the hydrogen storage tank 102 and the power generation device 104. In this embodiment, hydrogen is transferred from the hydrogen storage tank 102 to the power generation device 104 via a hydrogen tank transfer port, wherein the power generation device 104 converts the hydrogen into electrical energy which is then transferred to the power distribution device 106 for controlled distribution to the plurality of power consuming devices 108 connected to the system 100. This allows for the efficient management of the power distribution of the system 100.

For example, if the power generation device 104 is not functioning or otherwise inoperable, the power distribution device 106 could draw power from a public power supply 118. Alternatively, if the power generation device 104 is functioning at a reduced capacity or if more power is needed than the power generation device 104 can supply, the power distribution device 106 could controllably and switchingly or consistently draw power from both the public power supply 118 and the power generation device 104. Furthermore, if the system 100 is generating more power than is being used, or if desired, then the power distribution device 106 may direct the excess energy to the public power supply 118 for sale to the public utilities.

It should be appreciated that the power generation device 104 may convert hydrogen into electrical energy via any method suitable to the desired end purpose as is known in the industry. It should also be appreciated that the hydrogen storage tank may include a fuel inlet/outlet port 110 for receiving hydrogen from an outside source, such as a commercial hydrogen dealer and for delivering hydrogen to an outside source, such as a hydrogen vehicle 112. It is contemplated that the fuel inlet/outlet port 110 can also be used to deliver unused quantities of hydrogen to an outside source for sale. Furthermore, it should be appreciated that the power generation device 104 and/or the power distribution device 106 may include an electrical power inlet/outlet port 114 for delivering power to an outside source, such as a hybrid vehicle 116. It is also appreciated that, as discussed briefly hereinbefore, the electrical power inlet/outlet port 114 may be used to receive electrical power from an outside power source (or deliver electrical power to an outside power source for sale), such as the public power supply 118.

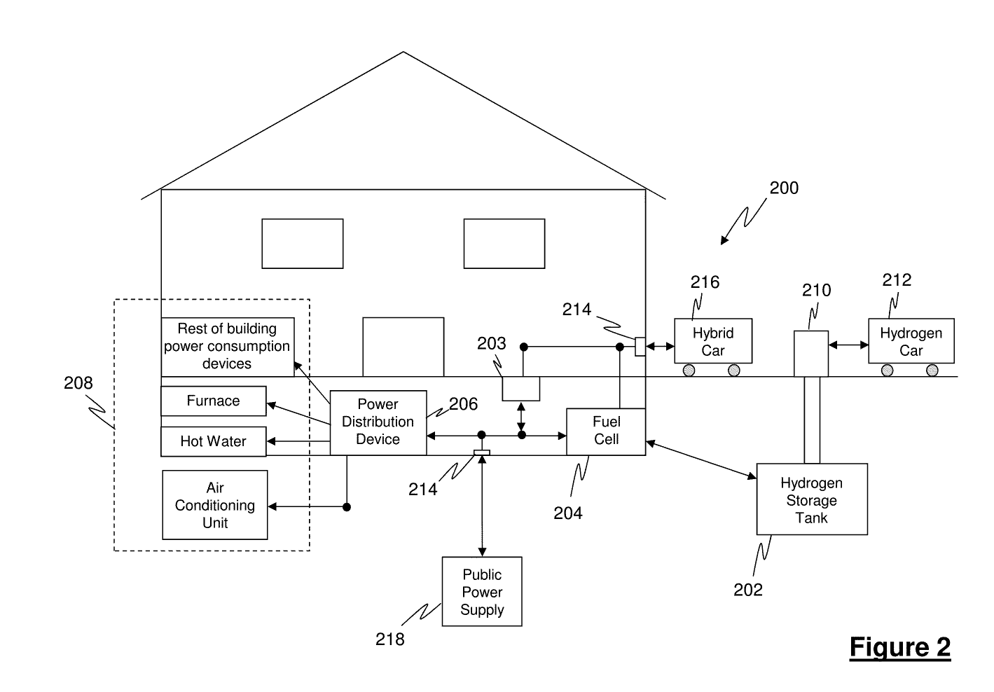

Referring to FIG. 2, a second embodiment of an energy generation and storage system 200 is illustrated and includes a hydrogen storage tank 202 and a power generation device 204 (such as an electrochemical fuel cell) associated with an energy storage device 203 (or battery cell) and a power distribution device 206 for controllably distributing power generated by the power generation device 204 to a plurality of power consuming devices 208. The hydrogen storage tank 202 is associated with the power generation device 204 to allow hydrogen to be transferred between the hydrogen storage tank 202 and the power generation device 204. In this embodiment, hydrogen is transferred from the hydrogen storage tank 202 to the power generation device 204, wherein the power generation device 204 converts the hydrogen into electrical energy which may then be transferred to the energy storage device 203 and/or the power distribution device 206 for a controlled distribution to the plurality of power consuming devices 208 connected to the system 200. This allows for the efficient management of the power distribution of the system 200.

In accordance with the present invention, the energy storage device 203 is associated with at least one of the energy storage device 203, the power generation device 204 and/or the public power supply 218, wherein the energy storage device 203 may receive and store energy from the power generation device 204. The energy storage device 203, the power generation device 204 and/or the public power supply 218 may also be associated with the power distribution device 206 to allow power from some, or all, of the energy storage device 203, the power generation device 204 and/or the public power supply 218 to be controllably distributed to power consuming devices 208.

For example, if the power generation device 204 is not functioning or otherwise inoperable, the power distribution device 206 could draw power from the public power supply 218 and/or the energy storage device 203. Alternatively, if the power generation device 204 is functioning at a reduced capacity or if more power is needed than the power generation device 204 can supply, the power distribution device 206 could controllably and switchingly or consistently draw power from the public power supply 218, the energy storage device 203 and/or the power generation device 204. Furthermore, if the system 200 is generating more power than is being used, or if desired, then the power distribution device 206 may direct the excess energy to the public power supply 218 for sale to the public utilities.

It should be appreciated that the power generation device 204 may convert hydrogen into electrical energy via any method suitable to the desired end purpose as is known in the industry. It should also be appreciated that the hydrogen storage tank 202 may include a fuel inlet/outlet port 210 for receiving hydrogen from an outside source, such as a commercial hydrogen dealer and/or for delivering hydrogen to an outside source, such as a hydrogen vehicle 212. It is contemplated that the fuel inlet/outlet port 210 can also be used to deliver unused quantities of hydrogen to an outside source for sale. Furthermore, it should be appreciated that the power generation device 204, energy storage device 203 and/or the power distribution device 206 may include an electrical power inlet/outlet port 214 for delivering power to an outside source, such as a hybrid vehicle 216. It is also appreciated that, as discussed briefly hereinbefore, the electrical power inlet/outlet port 214 may be used to receive electrical power from an outside power source (or deliver electrical power to an outside power source for sale), such as the public power supply 218.

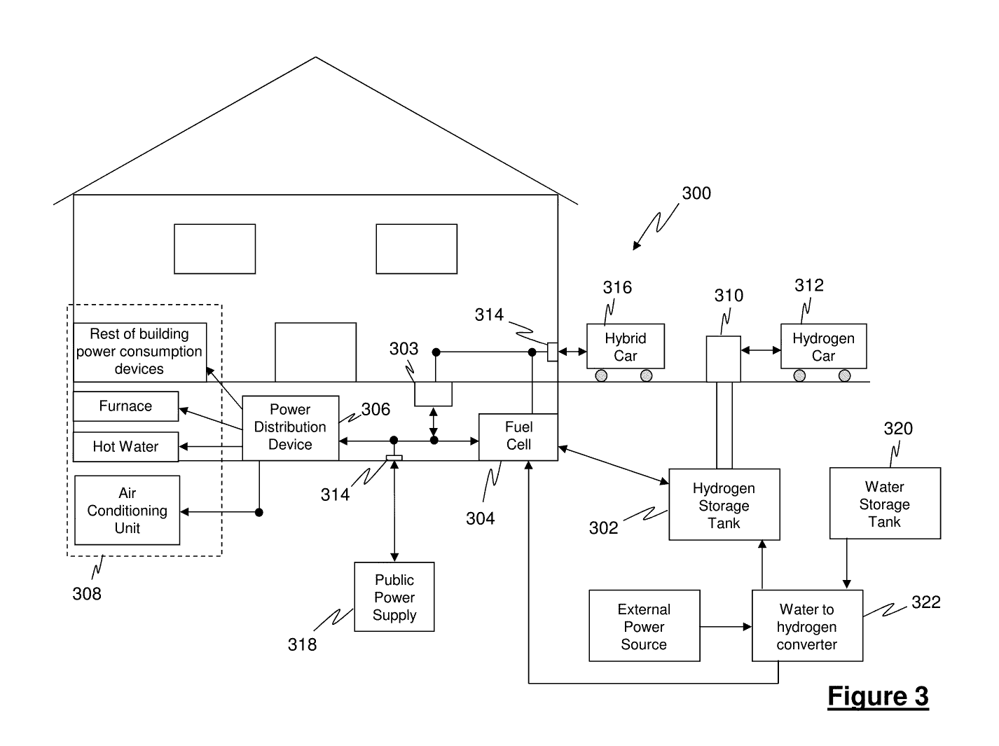

Referring to FIG. 3, a third embodiment of an energy generation and storage system 300 is illustrated and includes a hydrogen storage tank 302 and a power generation device 304 (such as an electrochemical fuel cell) associated with an energy storage device 303 and a power distribution device 306 for controllably distributing power generated by the power generation device 304 to a plurality of power consuming devices 308. The hydrogen storage tank 302 is associated with the power generation device 304 to allow hydrogen to be transferred between the hydrogen storage tank 302 and the power generation device 304. The energy generation and storage system 300 may also include a water (or other substance containing recoverable hydrogen) storage tank 320 associated with a hydrogen conversion/recovery device 322 (such as a water cracking device as is known in the art) for converting/recovering hydrogen from the water. The hydrogen conversion/recovery device 322 is further associated with the hydrogen storage tank 303, wherein hydrogen converted/recovered by the hydrogen conversion/recovery device 322 is transferred to the hydrogen storage tank 303 for future use and/or sale.

In this embodiment, hydrogen may be delivered and/or stored in the hydrogen storage tank 302 and/or hydrogen may be generated using the hydrogen conversion/recovery device 322. To accomplish this, a hydrogen source (such as water) may be stored in water storage tank 320 and/or called on demand from a well and/or public water supply and supplied to the hydrogen conversion/recovery device 322 which may be powered via an external power source (such as public power supply 318 or other device), a battery device and/or the system 300 itself. The hydrogen conversion/recovery device 322 generates hydrogen (“cracks”) from the water and transfers the hydrogen to the hydrogen storage tank 302. It is also contemplated that the hydrogen may be generated on demand and introduced directly into the system 300.

The hydrogen may then be transferred from the hydrogen storage tank 302 to the power generation device 304, wherein the power generation device 304 converts the hydrogen into electrical energy which may then be transferred to the energy storage device 303 and/or the power distribution device 306 for a controlled distribution of power to the plurality of power consuming devices 308 connected to the system 300. This allows for the efficient management of the power distribution of the system 300.

In accordance with the present invention, the energy storage device 303 is associated with at least one of the energy storage device 303, the power generation device 304 and/or the public power supply 318, wherein the energy storage device 303 may receive and store energy from the power generation device 304. The energy storage device 303, the power generation device 304 and/or the public power supply 318 may also be associated with the power distribution device 306 to allow power from some, or all, of the energy storage device 303, the power generation device 304 and/or the public power supply 318 to be controllably distributed to power consuming devices 308.

For example, if the power generation device 304 is not functioning or otherwise inoperable, the power distribution device 306 could draw power from the public power supply 318 and/or the energy storage device 303. Alternatively, if the power generation device 304 is functioning at a reduced capacity or if more power is needed than the power generation device 304 can supply, the power distribution device 306 could controllably and switchingly or consistently draw power from the public power supply 318, the energy storage device 303 and/or the power generation device 304. Furthermore, if the system 300 is generating more power than is being used, or if desired, then the power distribution device 306 may direct the excess energy to the public power supply 318 for sale to the public utilities.

It should be appreciated that the power generation device 304 may convert hydrogen into electrical energy via any method suitable to the desired end purpose as is known in the industry. It should also be appreciated that the hydrogen storage tank 302 may include a fuel inlet/outlet port 310 for receiving hydrogen from an outside source, such as a commercial hydrogen dealer and/or for delivering hydrogen to an outside source, such as a hydrogen vehicle 312. It is contemplated that the fuel inlet/outlet port 310 can also be used to deliver unused quantities of hydrogen to an outside source for sale. Furthermore, it should be appreciated that the power generation device 304, energy storage device 303 and/or the power distribution device 306 may include an electrical power inlet/outlet port 314 for delivering power to an outside source, such as a hybrid vehicle 316. It is also appreciated that, as discussed briefly hereinbefore, the electrical power inlet/outlet port 314 may be used to receive electrical power from an outside power source (or deliver electrical power to an outside power source for sale), such as the public power supply 318.

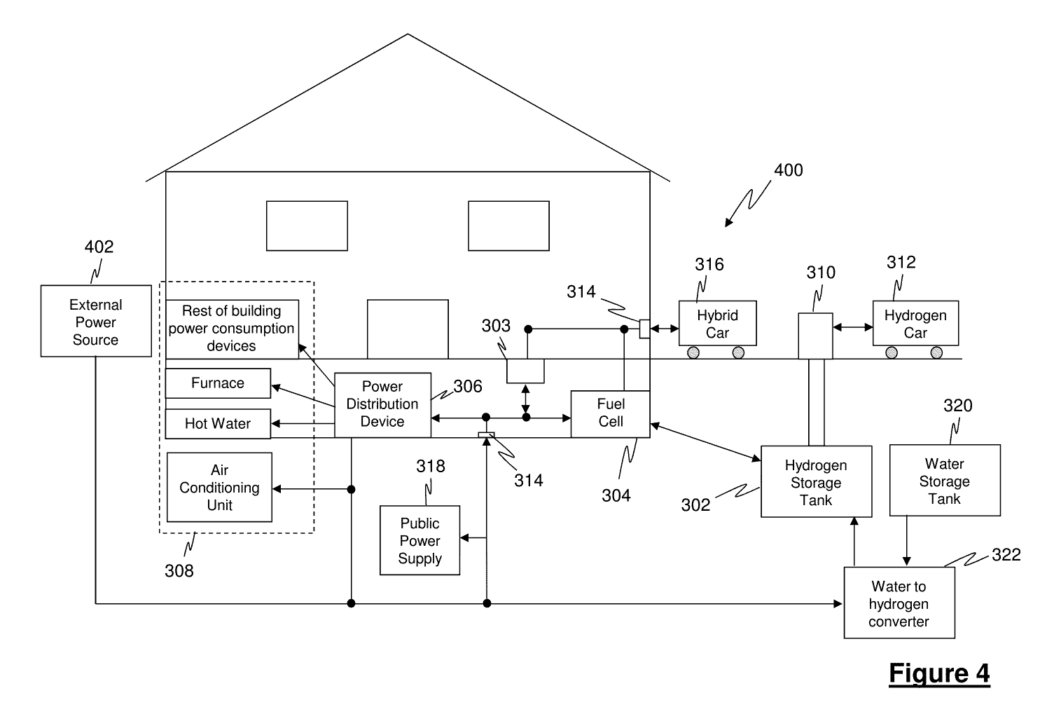

Referring to FIG. 4, a fourth embodiment of an energy generation and storage system 400 is illustrated and includes an external power source 402 that may be connected to at least one of the power distribution device 306, energy storage device 303, power generation device 304, public power supply 318 and hydrogen conversion/recovery device 322. It should be appreciated that the external power source 402 may be any type of device suitable to the desired end purpose of generating power, such as windmill for converting wind energy to electricity, a water mill for converting kinetic water power to electricity, solar panels for converting sun energy to electricity and/or a device for converting kinetic energy into electricity, such as an exercise device.

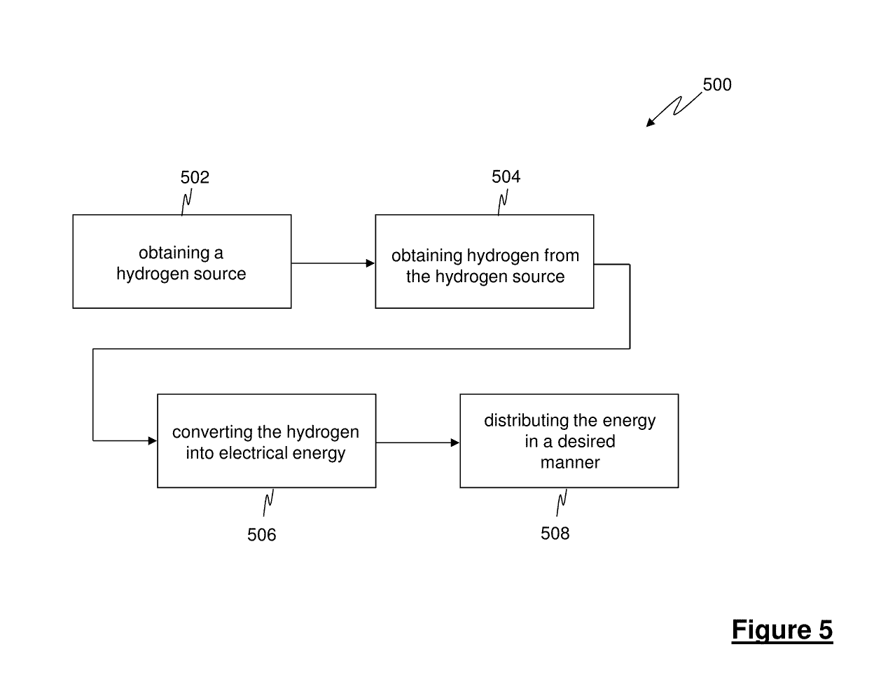

Referring to FIG. 5, a block diagram illustrating a method 500 for generating and managing energy is illustrated and includes obtaining a hydrogen source 102, 202, 302, 320, 322 as shown in operational block 502. In accordance with the present invention, the hydrogen source 102, 202, 302, 320 may be hydrogen stored in a storage tank 102, 202, 302 and/or water (or some other substance from which hydrogen can be recovered) stored in a water tank 320 or provided on demand by a well and/or a public water supply. The hydrogen is then obtained from the hydrogen source 102, 202, 302, 320, 322, as shown in operational block 504 and converted into electrical energy, as shown in operational block 506. If the hydrogen source 102, 202, 302, 320, 322 is a hydrogen tank 102, 202, 302, then this may be accomplished by transferring the hydrogen stored in the hydrogen tank 102, 202, 302 to a power generation device 102, 202, 302 or fuel cell which converts the hydrogen into electrical energy. On the other hand, if the hydrogen source is water (or some other substance from which hydrogen can be recovered) then the water is introduced into a hydrogen conversion/recovery device 322 or “water cracker” which recovers the hydrogen from the water. The recovered hydrogen may then be transferred to the power generation device 102, 202, 302 or fuel cell for conversion into electrical energy. Once the electrical energy has been generated, the electrical energy may be distributed as desired, as shown in operational block 508. Accordingly, the electrical energy may be distributed to the power consuming devices 108, 208, 308, 316, 322 for consumption, the battery for storage and future use and/or sale and/or to the public power supply 318 for sale.

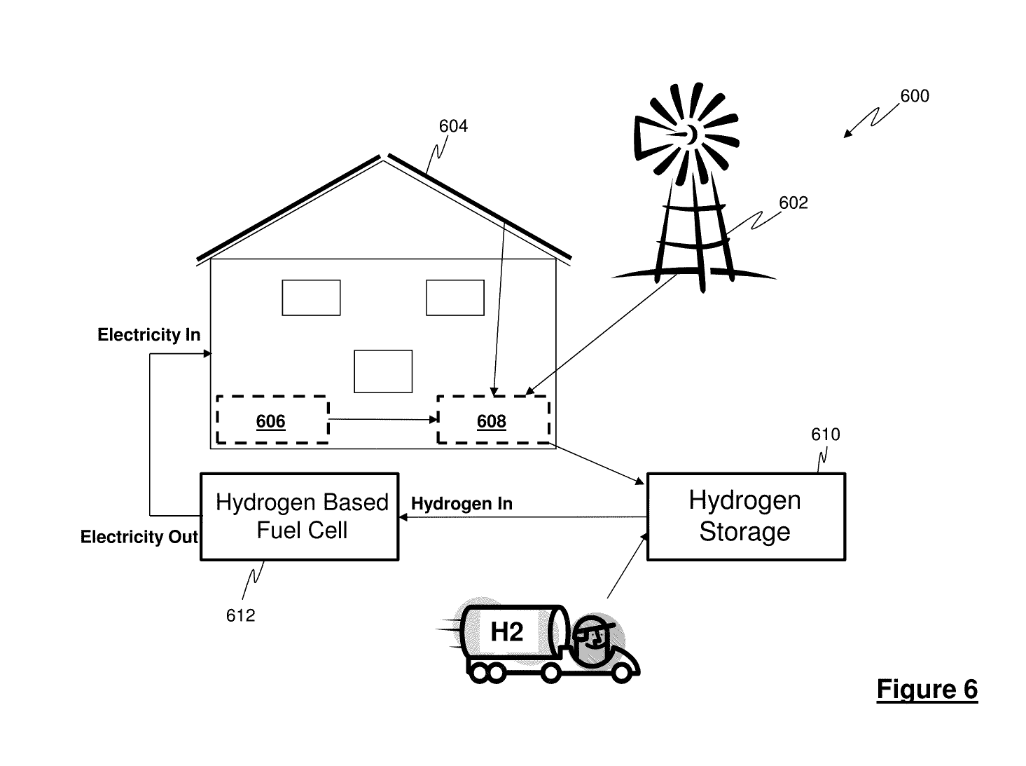

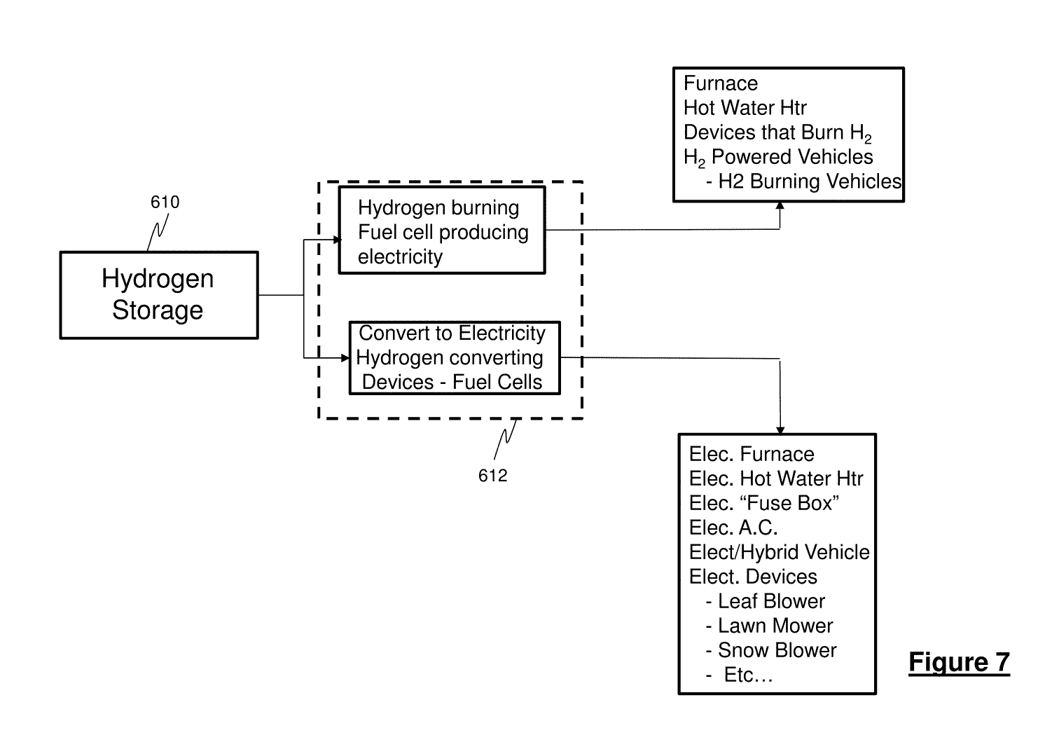

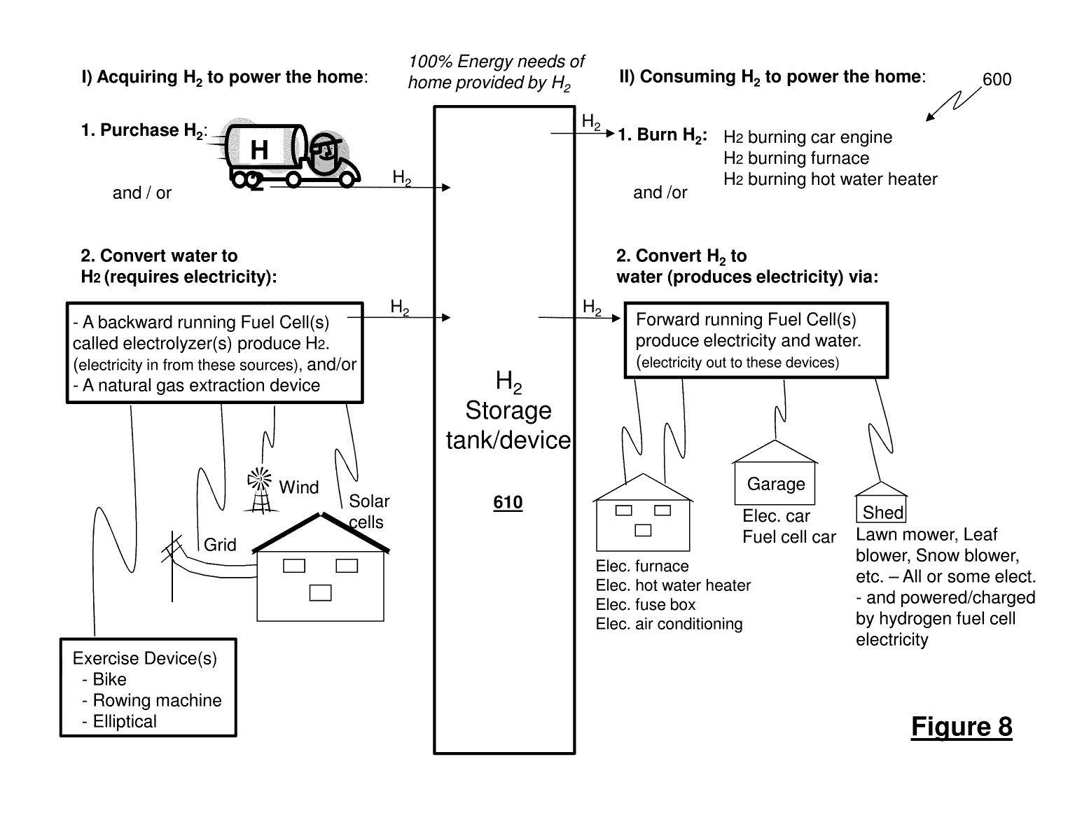

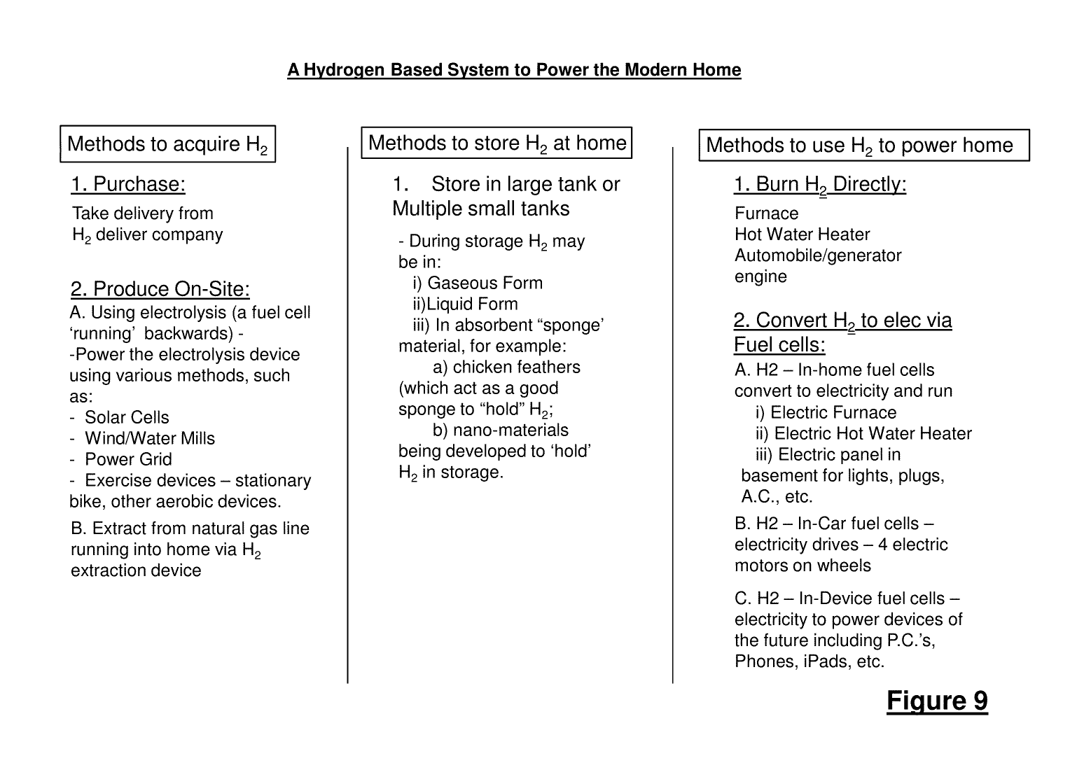

Referring to FIG. 6, FIG. 7, FIG. 8 and FIG. 9, a hydrogen based energy system 600 that can be used to power a building (such as a household) is provided and includes a wind power harnessing article 602, a solar power harnessing article 604, a personal-mechanical energy harnessing article 606, a hydrogen generation article 608 and a hydrogen storage article 610, in accordance with another embodiment of the invention. It should be appreciated that the wind power harnessing article 602, solar power harnessing article 604 and personal-mechanical energy harnessing article 606 (i.e. bike, elliptical, rowing machine, etc.) are connected to the hydrogen generation article 608, wherein the energy harnessed by the wind power harnessing article 602, solar power harnessing article 604 and personal-mechanical energy harnessing article 606 is used to drive the hydrogen generation article 608 to generate hydrogen which is then stored in the hydrogen storage article 610. The hydrogen based energy system 600 also includes a hydrogen based fuel cell 612 connected to the hydrogen storage article 610, where the hydrogen based fuel cell 612 convert the hydrogen into electricity for all of the electrical equipment in a household, such as an electric furnace, an electric hot water heater, electric distribution box (for powering stove, refrigerator, TV, lights, dishwasher, well-pump, etc.) and an electric air conditioner.

It should be appreciated that the hydrogen based energy system 600 may be used to power a modern house or building. The system 600 is configured to acquire hydrogen by 1) purchasing and taking delivery of hydrogen, and/or 2) producing hydrogen on-site via A) electrolysis (i.e. a fuel cell running backwards) where an electrolysis device may be powered via various methods, such as solar power, wind power, water power, power grid, generator or a personal (human/animal powered) mechanical device (stationary bike, aerobic machine, etc.) which converts mechanical energy into electrical energy, and/or B) via a natural gas extraction device.

The hydrogen may be stored via any device or method suitable to the desired end purpose, such as storage tank 610 (one large tank or several smaller tanks) and may be stored in gaseous form, liquid form or in a material configured to ‘retain’ and ‘hold’ hydrogen (such as an absorbent ‘sponge’ like material, including chicken feathers configured to ‘hold’ hydrogen or non-materials configured to ‘hold’ hydrogen and/or Nano-Particle Sponge). Additionally, it should be appreciated that any method and/or device may be used to deploy or convert hydrogen to power a building or house. For example, the hydrogen may be converted directly into electricity or heat using a converting unit (such as a furnace, a hot water heater, an engine, etc) and/or the hydrogen may be converted into electricity via one or more in-home (in-building) fuel cells, where the electricity is used to run/power an electric furnace, all or some of the electrical appliances/devices in a building via an electric distribution panel (i.e. lights, dishwasher, plugs, A.C., etc.). Moreover it is contemplated that 1) the hydrogen may be converted directly into electricity via one or more in-vehicle fuel cells, and/or 2) the hydrogen may be converted directly into electricity via one or more fuel cells located within the unit to be powered. For example, a dishwasher may receive hydrogen and convert the hydrogen into electricity or heat as needed via a hydrogen burner and/or fuel cell located within the dishwasher. Moreover, it is contemplated that the electricity generated through hydrogen may be used to power/charge any electric device, such as a lawn mower, leaf blower, snow blower, space heater, etc. Furthermore, the invention contemplates that individual devices themselves may include H₂ fuel cells to generate electricity.

Furthermore, it is contemplated that a control system may be provided, wherein the control system is configured to monitor and/or balance the energy being used and distributed. The control system may be configurable such that a user can prioritize usage and/or devices such that the control system redirects or disconnects power as need to keep higher level priority devices operating. For example, consider the situation where a house is being powered by hydrogen stored in the hydrogen storage tank 610 and the temperature is at a level below freezing. The control system monitors the hydrogen level, the energy usage and the rate at which hydrogen is being produced (if hydrogen production is occurring). The control system may include an algorithm that determines how long the hydrogen may last. In response to these parameters (or other parameters if desired), the control system may shed loads by disconnecting power to non-essential devices, such as a ceiling fan or a dishwasher. Additionally, the control system may disconnect power to plugs that are not being used, where the plug may be configured to sense when a load is applied and if a load is present, power would be restored.

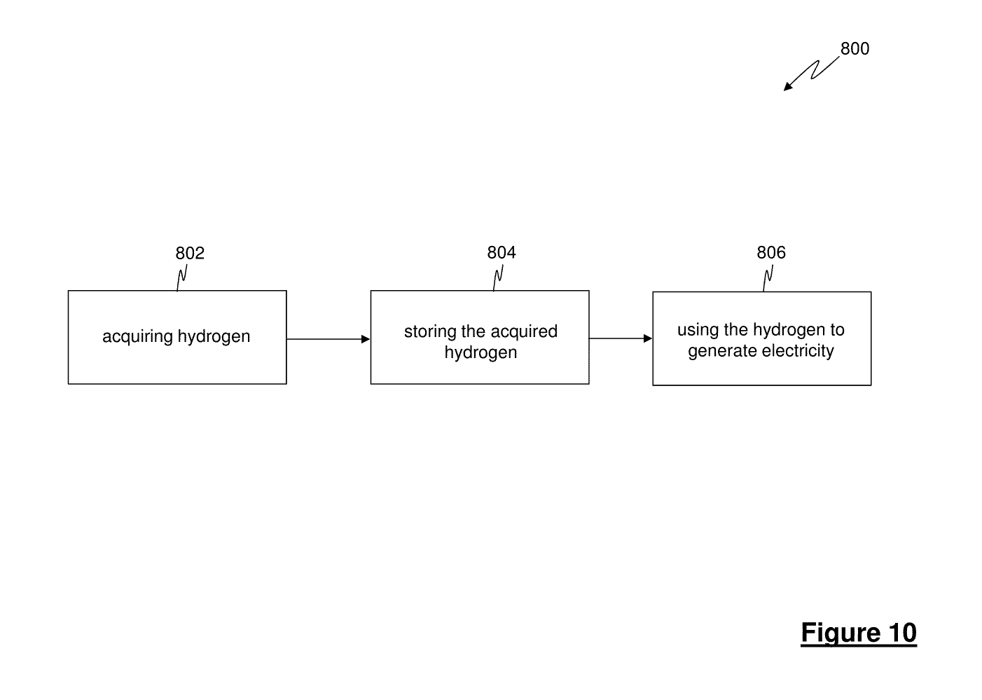

Referring to FIG. 10, a block diagram illustrating a method 800 for generating and managing energy in accordance with another embodiment is shown and includes acquiring hydrogen, as shown in operational block 802. It should be appreciated that the hydrogen may be acquired via any device and/or method available and suitable to the desired end purpose. As such, the hydrogen may be purchased from a second party and/or delivered via a hydrogen delivery company. Additionally, the hydrogen may be generated/produced/recovered on-site using electrolysis and/or other hydrogen recovery methods. For example, in some embodiments, the power for the hydrogen recovery device (such as the electrolysis device) may be provided via various methods such as, Solar Cells, Wind/Water Mills, Power Grid, Exercise devices and/or combustion engine. Additionally, the hydrogen may be extracted from a natural gas supply (such as from a natural gas line running into the home) via a hydrogen extraction device.

Once the hydrogen is acquired, the hydrogen is used and/or stored, as shown in operational block 804. Storage of the hydrogen may be accomplished using any storage method/device suitable to the desired end purpose. For example, in one embodiment, the hydrogen may be stored in one large tank and/or multiple small tanks. Additionally, if desired, during storage the hydrogen may be in gaseous form, liquid form and/or in an absorbent ‘sponge’ material such as, for example, chicken feathers and/or nano-materials that are configured to ‘hold’ hydrogen. Once the hydrogen is acquired and/or stored, the hydrogen is used to power the home (and/or any other building/device as desired), as shown in operational block 806. This may be accomplished via any method/device desired suitable to the desired end purpose. For example, the hydrogen may be burned directly via a hydrogen powered device, such as a furnace, a hot water heater, an automobile/generator engine, etc. Additionally, the hydrogen may be converted into electricity via fuel cells, such as in-home hydrogen fuel cells which can power electrical devices, including electric furnace, electric hot water heater, electric panel for distributing power throughout a building for lights, plugs, AC, etc. Furthermore, the hydrogen may be converted using in-car fuel cells and/or using in-device fuel cells (i.e. a device that contains a fuel cell for converting hydrogen into electricity).

It should be appreciated that the power distribution device 106, 206 and 306 of the energy generation and storage system 100, 200, 300, 400 may include a processing device and/or logic to control distribution of power, to monitor the elements of the system 100, 200, 300, 400 and/or to determine how power should be distributed. This would allow the energy generation and storage system 100, 200, 300, 400 to sense whether there is enough power in the system to sell back to the utilities, that more hydrogen needs to be obtained and/or whether any of the elements of the system 100, 200, 300, 400 require repair and/or maintenance. Additionally, it should be appreciated that the energy generation and storage system 100, 200, 300, 400 may include a hydrogen outlet configured to distribute hydrogen to hand-held or small hydrogen powered devices, such as PDA's, cell phones and lighters.

It should also be appreciated that the present invention may be applied to communities as well as individual consumers. For example, a neighborhood in a residential area may pool their resources to form a ‘local’ power company to satisfy their energy needs. Additionally, any ‘extra’ electricity or hydrogen produced may be sold to power companies or hydrogen supply companies. It is contemplated that the electricity and/or the hydrogen produced by the generation/storage systems 100, 200, 300, 400 may be used to fuel/operate any devices suitable to the desired end purpose, such as hot water heater, a hybrid vehicle (both electric and hydrogen operated), an air conditioning system, kitchen appliances, furnaces, televisions, stereos, water pumps, lights, etc. Accordingly, the electricity consuming devices may draw electricity by interfacing with the power distribution system 106, 206, 306, the fuel cell 104, 204, 304 and/or the battery 203, 303 via at least one power distribution port.

A machine-readable computer program code and/or a medium encoded with a machine-readable computer program code for implementing all or some of the method 500 of the invention, the code and/or medium including instructions for causing a controller to implement a method for generating and managing energy is provided. In accordance with an exemplary embodiment, the processing of the present invention may be implemented by a controller disposed internal, external or internally and externally to the Web server. In addition, processing of the present invention may be implemented through a controller operating in response to a computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Additionally, all or some of the method 500 of the invention may be embodied in the form of a computer or controller implemented processes. Furthermore, all or some of the method 500 of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The method 500 of the invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A system for generating power for a building, the system comprising:
a hydrogen source;
a hydrogen storage tank for containing hydrogen obtained from the hydrogen source; and
a hydrogen converting device configured to receive the hydrogen from the hydrogen storage tank, wherein the hydrogen converting device is configured to convert the hydrogen into energy.

2. A system for generating power for a building, the system comprising:
a hydrogen source,
a plurality of power generation sources,
a hydrogen recovery article, wherein the hydrogen recovery article is configured to interact with the hydrogen source and the plurality of power generation sources to generate hydrogen;
a hydrogen storage tank for containing the hydrogen;
an electrical energy generation device associated with the hydrogen storage tank and configured to receive the hydrogen, wherein the electrical energy generation device is configured to convert the hydrogen into electricity;
a plurality of power consuming articles in electrical communication with the electrical energy generation device such that the plurality of power consuming articles receives electricity from the electrical energy generation device; and
a power control system in electrical communication with the electrical energy generation device and the plurality of power consuming articles, wherein the power control system monitors power load on the electrical energy generation device from the plurality of power consuming articles and configures the connection between the plurality of power consuming articles and electrical energy generation device in response.

3. A system for generating power for a building, the system comprising:
a hydrogen source,
a plurality of power generation sources,
a hydrogen recovery article, wherein the hydrogen recovery article is configured to interact with the hydrogen source and the plurality of power generation sources to generate hydrogen;
a hydrogen storage tank for containing the hydrogen;
an electrical energy generation device associated with the hydrogen storage tank and configured to receive the hydrogen, wherein the electrical energy generation device is configured to convert the hydrogen into electricity; and
a plurality of power consuming articles in electrical communication with the electrical energy generation device such that the plurality of power consuming articles receives electricity from the electrical energy generation device.

4. The system for generating power for a building of claim 2, further comprising a power control system in electrical communication with the electrical energy generation device and the plurality of power consuming articles, wherein the power control system monitors power load on the electrical energy generation device from the plurality of power consuming articles and configures the connection between the plurality of power consuming articles and electrical energy generation device in response.
